(19) United States
(12) Patent Application Publication
(10) Pub. No.: US 2022/0355880 A1
(43) Pub. Date: Nov. 10, 2022

(54) BICYCLE BELL

(71) Applicant: Royal Danish Vendors A/S, Hillerød (DK)

(72) Inventors: Søren BLAABJERG, Hillerød (DK); Tine BLAABJERG, Hillerød (DK)

(73) Assignee: Royal Danish Vendors A/S, Hillerød (DK)

(21) Appl. No.: 17/603,632

(22) PCT Filed: Apr. 3, 2020
(86) PCT No.: PCT/EP2020/059609

§ 371 Date: Oct. 14, 2021

(30) Foreign Application Priority Data
Apr. 15, 2019 (DK) PA 2019 70237

(51) Int. Cl. B62J 3/04; G10K 1/072

(52) U.S. Cl. CPC B62J 3/04; G10K 1/072

(57) ABSTRACT

The bicycle bell includes a bell body, a thumb-operated clapper or lever adapted to strike the bell body in order to produce a sound, a frame element holding the bell body and the thumb-operated clapper or lever, and a mounting mechanism carrying the frame element. The mounting mechanism includes a mounting shoe having at least one abutment surface adapted to abut a flat surface of an object and a permanent magnet arranged in the mounting shoe, and the at least one abutment surface of the mounting shoe spans at least a distance corresponding to a third of a largest dimension of the bell body.

The present invention relates to a bicycle bell including a bell body, a thumb-operated clapper or lever adapted to strike the bell body in order to produce a sound, a frame element holding the bell body and the thumb-operated clapper or lever, and a mounting mechanism carrying the frame element.

A well-known bicycle bell is provided with a mounting mechanism in the form of a bracket adapted to grip over and clamp about handlebars of a bike. However, this mounting mechanism is not suitable for mounting the bicycle bell on a flat surface, such as the surface of a refrigerator, for decoration purposes.

The object of the present invention is to provide a bicycle bell suitable for stable mounting on a flat magnetic surface.

In view of this object, the mounting mechanism includes a mounting shoe having at least one abutment surface adapted to abut a flat surface of an object and a permanent magnet arranged in the mounting shoe, and the at least one abutment surface of the mounting shoe spans at least a distance corresponding to a third of a largest dimension of the bell body.

In this way, by providing a mounting shoe having a suitably broad abutment surface adapted to abut a flat surface and a permanent magnet, the bicycle bell may be steadily mounted on any flat metal surface or magnetic surface, such as the surface of a refrigerator or the like, and because of the steady mounting, which may prevent tipping of the bell in relation to the surface it is mounted on, the bicycle bell may furthermore be used to provide a sound by operating the thumb-operated clapper or lever to strike the bell in the same way as it is done with prior art bicycle bells when mounted on the handlebars of a bike.

In an embodiment, the mounting shoe includes a ring-formed element forming the at least one abutment surface, and the permanent magnet is inserted into the ring-formed element flush with the at least one abutment surface of the mounting shoe. The permanent magnet may have the form of a disc and it may be glued into the ring-formed element.

In an embodiment, the ring-formed element is produced from a metal plate in a stamping operation, and an inner edge of the ring-formed element is bent to conform to an edge of the permanent magnet. The permanent magnet may have the form of a disc and it may preferably be glued into the bent edge of the ring-formed element.

In an embodiment, the mounting shoe includes a conical element having a narrow top end and a wide bottom end, the conical element is produced from a metal plate in a stamping operation, and the frame element is attached to the narrow top end and the at least one abutment surface is arranged at the wide bottom end. Thereby, a stable mounting of the bicycle bell on a flat surface may be achieved in a simple manner.

In an embodiment, an outer edge of the ring-formed element is bent about an outer edge of the wide bottom end of the conical element. Thereby, a solid connection may be achieved between the ring-formed element and the conical element.

In an embodiment, the narrow top end of the conical element has a bent-in edge abutting a recess of a pin forming part of or forming the frame element.

In an embodiment, the mounting shoe includes a conical element having a narrow top end and a wide bottom end, and the frame element is attached to the narrow top end and the at least one abutment surface is arranged at the wide bottom end. Thereby, a stable mounting of the bicycle bell on a flat surface may be achieved in a simple manner.

In an embodiment, the bell body has a longitudinal axis arranged coaxially with the conical element, the bell body has a largest diameter, and the wide bottom end of the conical element has a diameter larger than ⅓, preferably larger than ½, of the largest diameter of the bell body. Thereby, an even more stable mounting of the bicycle bell on a flat surface may be achieved.

In an embodiment, the frame element has the form of a pin, a first end of which is attached to a centre of the bell body, and a second end of which is attached to narrow top end of the conical element.

In an embodiment, a thumb-operated clapper is spring-mounted to the pin forming the frame element.

The invention will now be explained in more detail below by means of examples of embodiments with reference to the very schematic drawing, in which

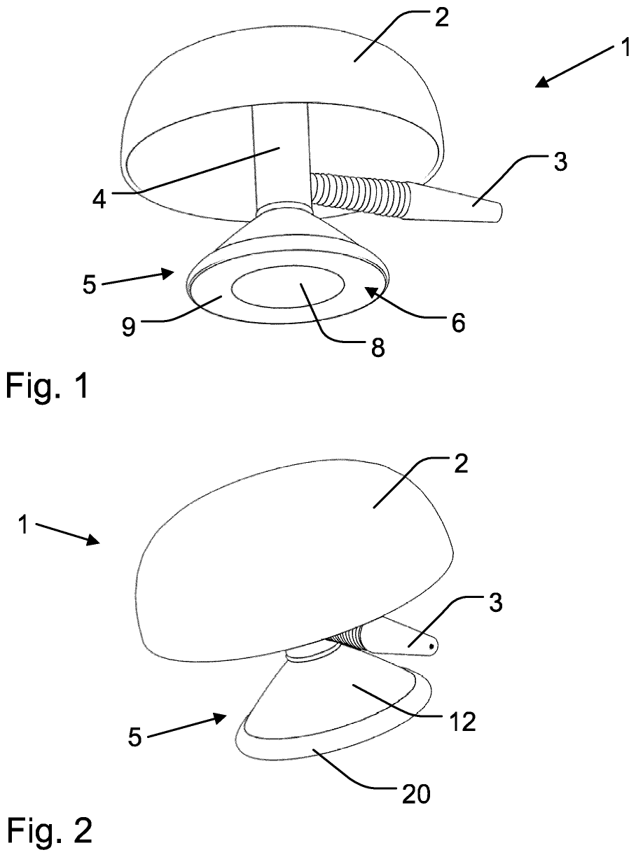

FIG. 1 is a perspective view of the bicycle bell according to the invention, seen from below;

FIG. 2 is a perspective view of the bicycle bell of FIG. 1, seen from above;

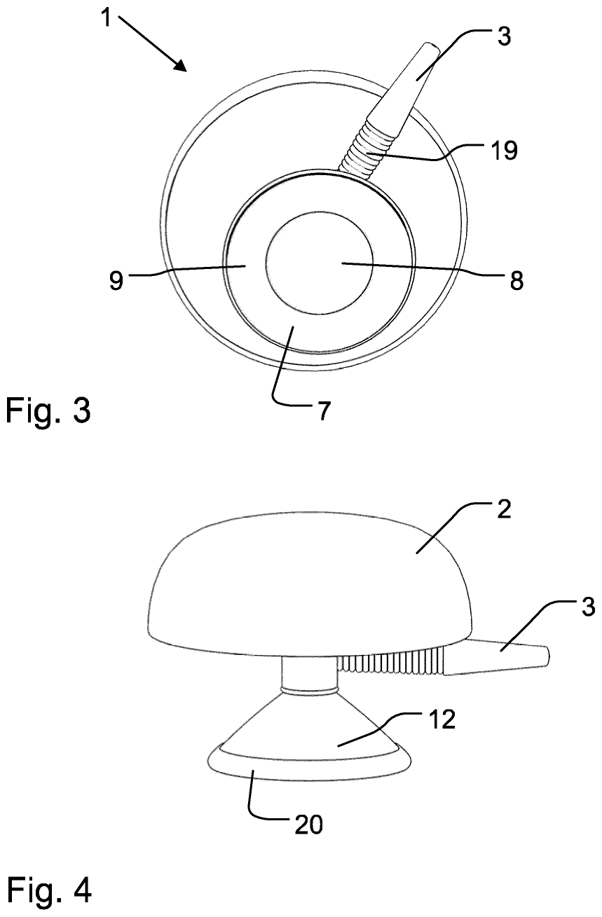

FIG. 3 is a perspective view of the bicycle bell of FIG. 1, seen from another angle from below;

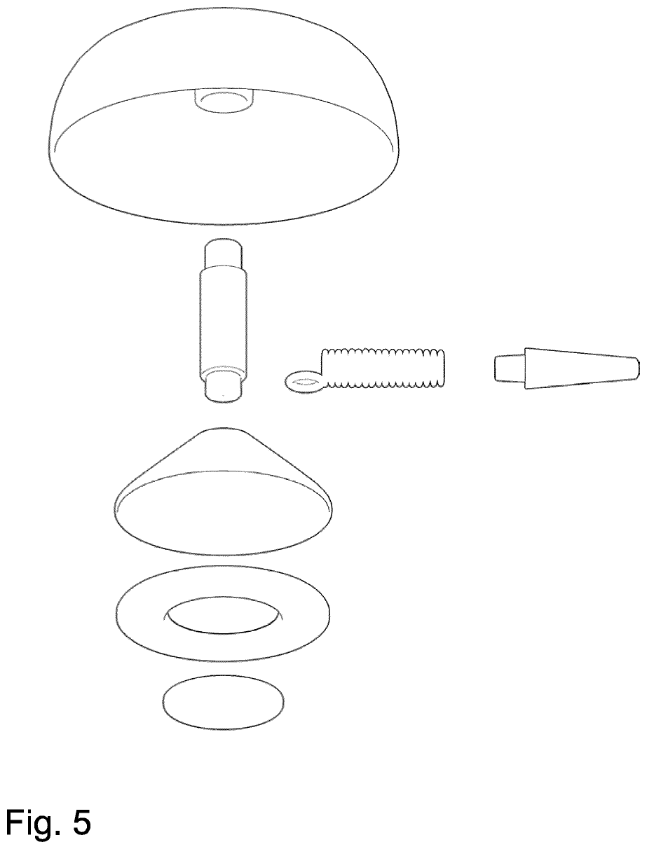

FIG. 4 is a side view of the bicycle bell of FIG. 1;

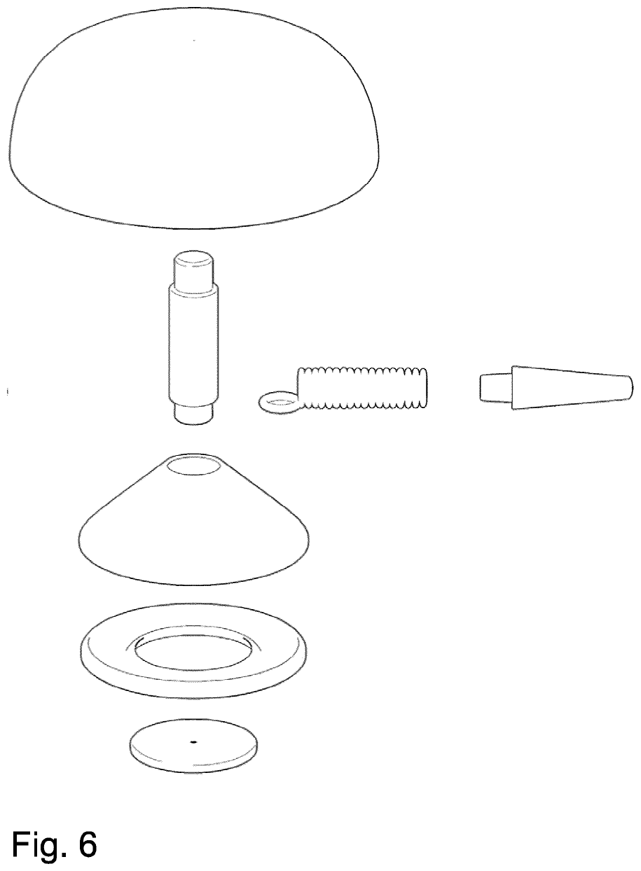

FIG. 5 is a perspective, exploded view of the bicycle bell according to the invention, seen from below;

FIG. 6 is a perspective, exploded view corresponding to that of FIG. 5, seen from above; and

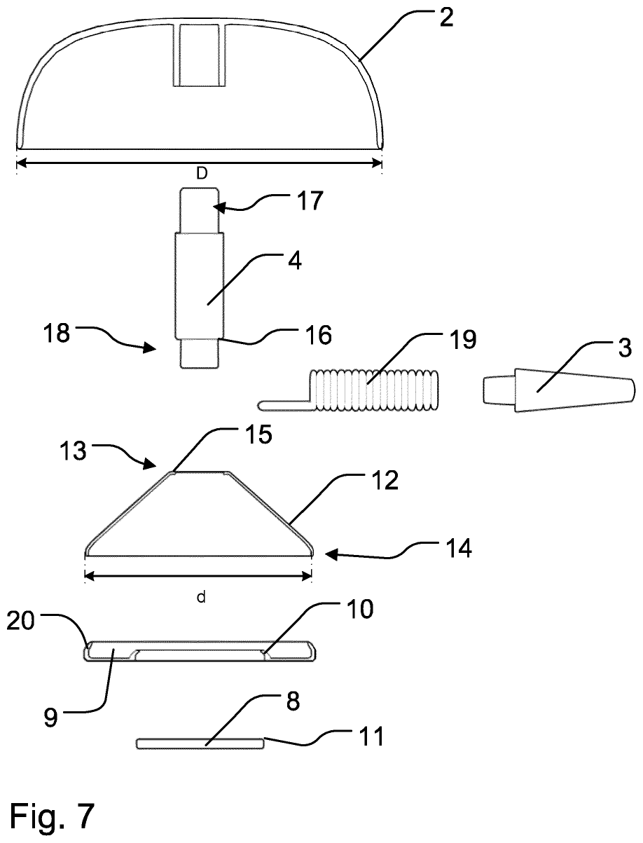

FIG. 7 is an exploded side view of the bicycle bell according to the invention.

FIG. 1 shows a bicycle bell 1 including a bell body 2, a thumb-operated clapper 3 or lever adapted to strike the bell body 2 in order to produce a sound, a frame element 4 holding the bell body and the thumb-operated clapper or lever, and a mounting mechanism 5 carrying the frame element.

The illustrated bicycle bell 1 is of a quite simple type, with a spring-mounted external clapper that produces a “ding-ding” sound when the clapper is pulled with a finger and released. However, the present invention is equally applicable to other types of bells, such as the more traditional type, wherein the bell is actuated by a thumb-operated lever that is geared to rapidly rotate two loosely slung metal discs inside the bell housing. Said discs repeatedly rattle and strike the bell to produce a sound not unlike that of an electric bell. This known type of bell is mounted on handle bars of bicycles.

As seen in the figures, according to the present invention, the mounting mechanism 5 includes a mounting shoe 6 having at least one abutment surface 7 adapted to abut a flat surface of an object and a permanent magnet 8 arranged in the mounting shoe 6, and the at least one abutment surface 7 of the mounting shoe spans at least a distance d corresponding to a third of a largest dimension D of the bell body 2.

The mounting shoe 6 includes a ring-formed element 9 forming the at least one abutment surface 7, and the permanent magnet 8 is inserted into the ring-formed element 9 flush with the at least one abutment surface 7 of the mounting shoe.

The ring-formed element 9 is produced from a metal plate in a stamping operation, and an inner edge 10 of the ring-formed element is bent to conform to an edge 11 of the permanent magnet 8.

The mounting shoe 6 includes a conical element 12 having a narrow top end 13 and a wide bottom end 14. The conical element is produced from a metal plate in a stamping operation, and the frame element 4 is attached to the narrow top end 13 and the at least one abutment surface 7 is arranged at the wide bottom end 14.

An outer edge 20 of the ring-formed element 9 is bent about an outer edge of the wide bottom end 14 of the conical element 12. Thereby, a solid connection between the ring-formed element 9 and the conical element 12 may be achieved.

The narrow top end 13 of the conical element 12 has a bent-in edge 15 abutting a recess 16 of a pin forming part of or forming the frame element 4.

The mounting shoe 6 includes a conical element 12 having a narrow top end 13 and a wide bottom end 14, and the frame element 4 is attached to the narrow top end 13 and the at least one abutment surface 7 is arranged at the wide bottom end 14.

According to the invention, the bell body 2 has a longitudinal axis arranged coaxially with the conical element 12, the bell body has a largest diameter D, and the wide bottom end 14 of the conical element 12 has a diameter larger than ⅓, preferably larger than ½, of the largest diameter D of the bell body.

Referring to FIG. 7, in the illustrated embodiment, the wide bottom end 14 of the conical element 12 has a diameter d corresponding to approximately 0.6 times the largest diameter D of the bell body.

The frame element 4 has the form of a pin, a first end 17 of which is attached to a centre of the bell body, and a second end 18 of which is attached to narrow top end 13 of the conical element 12, preferably by means of a press fitting.

In the illustrated embodiment, the thumb-operated clapper 3 is spring-mounted 19 to the pin forming the frame element 4.

1. A bicycle bell including a bell body, a thumb-operated clapper or lever adapted to strike the bell body in order to produce a sound, a frame element holding the bell body and the thumb-operated clapper or lever, and a mounting mechanism carrying the frame element, wherein the mounting mechanism includes a mounting shoe having at least one abutment surface adapted to abut a flat surface of an object and a permanent magnet arranged in the mounting shoe, and in that the at least one abutment surface of the mounting shoe spans at least a distance corresponding to a third of a largest dimension of the bell body.

2. A bicycle bell according to claim 1, wherein the mounting shoe includes a ring-formed element forming the at least one abutment surface, and wherein the permanent magnet is inserted into the ring-formed element flush with the at least one abutment surface of the mounting shoe.

3. A bicycle bell according to claim 2, wherein the ring-formed element is produced from a metal plate in a stamping operation, and wherein an inner edge of the ring-formed element is bent to conform to an edge of the permanent magnet.

4. A bicycle bell according to claim 3, wherein the mounting shoe includes a conical element having a narrow top end and a wide bottom end, wherein the conical element is produced from a metal plate in a stamping operation, and wherein the frame element is attached to the narrow top end and the at least one abutment surface is arranged at the wide bottom end.

5. A bicycle bell according to claim 4, wherein an outer edge of the ring-formed element is bent about an outer edge of the wide bottom end of the conical element.

6. A bicycle bell according to claim 4, wherein the narrow top end of the conical element has a bent-in edge abutting a recess of a pin forming part of or forming the frame element.

7. A bicycle bell according to claim 1, wherein the mounting shoe includes a conical element having a narrow top end and a wide bottom end, and wherein the frame element is attached to the narrow top end and the at least one abutment surface is arranged at the wide bottom end.

8. A bicycle bell according to claim 7, wherein the bell body has a longitudinal axis arranged coaxially with the conical element, wherein the bell body has a largest diameter, and wherein the wide bottom end of the conical element has a diameter larger than ⅓, preferably larger than ½, of the largest diameter of the bell body.

9. A bicycle bell according to claim 7, wherein the frame element has the form of a pin, a first end of which is attached to a centre of the bell body, and a second end of which is attached to narrow top end of the conical element.

10. A bicycle bell according to claim 9, wherein a thumb-operated clapper is spring-mounted to the pin forming the frame element.

11. A bicycle bell according to claim 5, wherein the narrow top end of the conical element has a bent-in edge abutting a recess of a pin forming part of or forming the frame element.

12. A bicycle bell according to claim 2, wherein the mounting shoe includes a conical element having a narrow top end and a wide bottom end, and wherein the frame element is attached to the narrow top end and the at least one abutment surface is arranged at the wide bottom end.

13. A bicycle bell according to claim 3, wherein the mounting shoe includes a conical element having a narrow top end and a wide bottom end, and wherein the frame element is attached to the narrow top end and the at least one abutment surface is arranged at the wide bottom end.

14. A bicycle bell according to claim 4, wherein the mounting shoe includes a conical element having a narrow top end and a wide bottom end, and wherein the frame element is attached to the narrow top end and the at least one abutment surface is arranged at the wide bottom end.

15. A bicycle bell according to claim 5, wherein the mounting shoe includes a conical element having a narrow top end and a wide bottom end, and wherein the frame element is attached to the narrow top end and the at least one abutment surface is arranged at the wide bottom end.

16. A bicycle bell according to claim 6, wherein the mounting shoe includes a conical element having a narrow top end and a wide bottom end, and wherein the frame element is attached to the narrow top end and the at least one abutment surface is arranged at the wide bottom end.

17. A bicycle bell according to claim 8, wherein the frame element has the form of a pin, a first end of which is attached to a centre of the bell body, and a second end of which is attached to narrow top end of the conical element.
